(19) United States
(12) Patent Application Publication
(10) Pub. No.: US 2007/0297975 A1
(43) Pub. Date: Dec. 27, 2007

(54) Metal loading of molecular sieves using organic carriers with limited water content

(76) Inventor: Marcel J. Janssen, Kessel-Lo (BE)

Correspondence Address: Exxon Mobil Chemical Company;Law Technology, P.O. Box 2149, Baytown, TX, 77522-2149, US

(21) Appl. No.: 11/800,645

(22) Filed: May 7, 2007

Related U.S. Application Data
(60) Provisional application No. 60/816,096, filed on Jun. 23, 2006.

(51) Int. Cl. C01B 39/04; C01B 39/02

(52) U.S. Cl. 423/702; 423/701

(57) ABSTRACT

The present invention relates to processes for preparing modified molecular sieves, as well as catalytic processes utilizing same. More particularly, the present invention relates to processes for preparing metal-containing molecular sieve coatings, and preferably metal oxide-coated molecular sieves. The present invention also includes the catalytic sieves made according to these processes.

### CROSS REFERENCE TO RELATED APPLICATION

This claims the benefit of and priority from U.S. Ser. No. 60/816,096, filed Jun. 23, 2006. The above application is fully incorporated herein by reference.

### FIELD OF THE INVENTION

The present invention relates to modified molecular sieves, as well as processes for preparing them and catalytic processes utilizing them. More particularly, the present invention relates to processes for preparing metal-containing coatings on molecular sieves that can be treated to form metal oxide-coated molecular sieves, as well as the sieves made according to these processes.

### BACKGROUND OF THE INVENTION

Molecular sieves are widely used as catalytic materials for a wide variety of chemical reactions. Efforts have been, and continue to be, made to modify catalytic molecular sieves for one or more reasons usually relating to some sort of catalyst performance, e.g., to increase and/or maintain for a longer time the catalytic activity of the molecular sieve. As a result, there are many publications describing processes for making modified molecular sieves and for modifying pre-existing molecular sieves.

For example, U.S. Pat. No. 5,939,349 discloses a method of preparing a non-zeolitic molecular sieve in which an active source of a hydrogenation component is added to the sieve particulates using a non-aqueous solvent to improve catalyst performance.

U.S. Pat. No. 6,040,264 discloses alkaline earth metal containing non-zeolitic molecular sieves and methods for making same in situ or modifying pre-synthesized sieves. Post-synthesis modification is taught to be accomplished using an aqueous solution of the desired metal dissolved under mild conditions.

U.S. Patent Application Publication No. 2005/0101819 A1 discloses dual functional catalysts for selective opening of cyclic paraffins containing a pre-synthesized molecular sieve, a refractory inorganic oxide, a Group VIII metal such as platinum, and a modifier component such as niobium or ytterbium. The process of modifying the catalyst disclosed in this reference includes spray or evaporative impregnation or ion exchange either with the molecular sieve or the refractory inorganic oxide, using a solution of a compound that is decomposable upon heating to form the catalytic metals or metal oxides. The Examples in this reference each specify that an aqueous solution is used.

International Publication No. WO 2005/002726 A1 discloses a catalyst useful in preparing middle distillates and lube bases from hydrocarbon feedstocks, as well as the process for making the catalyst. This reference teaches catalysts having hydro-dehydrogenating activity, typically with a binder, and that are modified by an impregnation method to modify the catalyst with the particular metal. As an alternate to the impregnation method, the reference teaches an ion exchange process that uses an aqueous solution of an inorganic salt of the desired metal, kept at a basic pH (8.5-11) using ammonium hydroxide.

However, it has been recognized that contact with water can destroy some of the catalytic properties of molecular sieves. For example, U.S. Pat. No. 6,316,683 teaches that exposure of synthesized molecular sieves to moisture/water can destroy its catalytic relatively quickly. This reference also teaches methods of protecting the catalytic activity of molecular sieves by reducing/eliminating exposure of the sieves to water.

Furthermore, most post-synthesis modification processes for adding metal or metal oxide functionality to a molecular sieve involve either depositing the metal or metal oxide (or precursor) only on the outer surface of the sieve (e.g., spray impregnation) or processing a pre-synthesized molecular sieve containing the templating agents (e.g., typically found within the pore structure) used in crystallization of the sieve.

For instance, U.S. Pat. No. 6,448,197 discloses a method for making a metal-containing small-pore molecular sieve catalyst. The method in this reference includes using a metal salt solution to coat the molecular sieve while the templating agent is still positioned within the pore structure.

Thus, the need exists in the art for processes for modifying molecular sieves that utilize template agent-free molecular sieves for modification and/or that utilize semi-aqueous solutions as a dispersion medium.

### SUMMARY OF THE INVENTION

One aspect of the present invention relates to a process for preparing a modified molecular sieve comprising contacting a molecular sieve substantially free from templating agents with a metal salt in an organic medium under conditions sufficient to disperse the metal salt on the surface and/or in/among the pores of the molecular sieve, thus forming a metal-containing molecular sieve, and treating (e.g., oxidizing) the metal-containing molecular sieve under conditions sufficient to form a modified molecular sieve, such that the molecular sieve loses not more than about 40% crystallinity.

Another aspect of the present invention relates to a process for preparing a modified molecular sieve comprising contacting a molecular sieve with a metal salt in a semi-aqueous medium under conditions sufficient to disperse the metal salt on the surface and/or in/among the pores of the molecular sieve, and treating (e.g., oxidizing) the metal-containing molecular sieve under conditions sufficient to form a modified molecular sieve, such that the molecular sieve loses not more than about 40% crystallinity.

Yet another aspect of the present invention relates to a modified molecular sieve made according to a process according to the invention. Such modified molecular sieves can be used as catalysts in many chemical processes, e.g., naphtha reforming, steam reforming, carbonaceous (e.g., CO) combustion, dehydrogenation, hydrogenation, dewaxing, oxygenate-to-olefin (OTO) conversion, condensation, dehydration, hydration, (co)polymerization, (co)oligomerization, and the like, and combinations thereof.

Further, as described herein, it is contemplated that embodiments listed separately, even in different aspects of the invention described herein, may be combined together with one or more other embodiments, provided that the embodiments do not have features that are mutually exclusive.

### BRIEF DESCRIPTION OF THE DRAWINGS

FIG. 1 is a graphical representation of XRD spectra of oxidized metal-coated molecular sieves impregnated using varying amounts of water in the impregnation medium.

### DETAILED DESCRIPTION OF THE INVENTION

### A. Introduction

One aspect of the present invention relates to a process for preparing a modified molecular sieve comprising contacting a molecular sieve substantially free from templating agents with a metal salt in an organic medium under conditions sufficient to disperse the metal salt on the surface and/or in/among the pores of the molecular sieve, thus forming a metal-containing molecular sieve, and treating (e.g., oxidizing) the metal-containing molecular sieve under conditions sufficient to form a modified molecular sieve, such that the molecular sieve loses not more than about 40% crystallinity.

Another aspect of the present invention relates to a process for preparing a modified molecular sieve comprising contacting a molecular sieve with a metal salt in a semi-aqueous medium under conditions sufficient to disperse the metal salt on the surface and/or in/among the pores of the molecular sieve, and treating (e.g., oxidizing) the metal-containing molecular sieve under conditions sufficient to form a modified molecular sieve, such that the molecular sieve loses not more than about 40% crystallinity.

Yet another aspect of the present invention relates to a modified molecular sieve made according to a process according to the invention. Such modified molecular sieves can be used as catalysts in many chemical processes, e.g., naphtha reforming, steam reforming, carbonaceous (e.g., CO) combustion, dehydrogenation, hydrogenation, dewaxing, oxygenate-to-olefin (OTO) conversion, condensation, dehydration, hydration, (co)polymerization, (co)oligomerization, and the like, and combinations thereof.

### B. Specifics and Formation of Starting Molecular Sieves

Molecular sieves have various chemical, physical, and framework characteristics and have been well classified by the Structure Commission of the International Zeolite Association according to the rules of the IUPAC Commission on Zeolite Nomenclature. A framework-type describes the topology and connectivity of the tetrahedrally coordinated atoms constituting the framework, and makes an abstraction of the specific properties for those materials. Framework-type zeolite and zeolite-type molecular sieves, for which a structure has been established, are assigned a three letter code and are described in the Atlas of Zeolite Framework Types, 5th edition, Elsevier, London, England (2001), which is herein fully incorporated by reference. Molecular sieves catalysts herein can include zeolite-based and/or non-zeolite-based.

Non-limiting examples of these molecular sieves are the small pore molecular sieves, AEI, AFT, APC, ATN, ATT, ATV, AWW, BIK, CAS, CHA, CHI, DAC, DDR, EDI, ERI, GOO, KFI, LEV, LOV, LTA, MON, PAU, PHI, RHO, ROG, THO, and substituted forms thereof, the medium pore molecular sieves, AFO, AEL, EUO, HEU, FER, MEL, MFI, MTW, MTT, TON, and substituted forms thereof, and the large pore molecular sieves, EMT, FAU, and substituted forms thereof. Other molecular sieves include ANA, BEA, CFI, CLO, DON, GIS, LTL, MER, MOR, MWW and SOD. Non-limiting examples of the preferred molecular sieves, particularly for converting an oxygenate containing feedstock into olefin(s), include AEL, AEI, AFY, BEA, CHA, EDI, FAU, FER, GIS, LTA, LTL, MER, MFI, MOR, MTT, MWW, TAM and TON. In one preferred embodiment, the molecular sieve of the invention has an AEI topology or a CHA topology, or a combination thereof, most preferably a CHA topology.

Crystalline molecular sieve materials all have 3-dimensional, four-connected framework structure of corner-sharing TO₄ tetrahedra, where T is any tetrahedrally coordinated cation. These molecular sieves are typically described in terms of the size of the ring that defines a pore, where the size is based on the number of T atoms in the ring. Other framework-type characteristics include the arrangement of rings that form a cage, and when present, the dimension of channels, and the spaces between the cages. See van Bekkum, et al., Introduction to Zeolite Science and Practice, Second Completely Revised and Expanded Edition, Volume 137, pages 1-67, Elsevier Science, B. V., Amsterdam, Netherlands (2001).

The small, medium and large pore molecular sieves have from a 4-ring to a 12-ring or greater framework-type. In a preferred embodiment, the molecular sieves used in the present invention have 8-ring or larger structures or larger and a pore size in the range of from about 3 Å to about 15 Å. In an embodiment, the structure of the molecular sieve is preferably an 8-, 10-, or 12-ring structure, and more preferably an 8-ring structure. The pore sizes of the molecular sieves are substantially uniform. In an embodiment, the pore size of the molecular sieve is from about 3 angstroms to about 15 angstroms, more preferably less than about 12 Å, more preferably less than about 10 Å, more preferably less than about 8 Å, more preferably less than about 6 Å, more preferably in the range of from 3 Å to about 5 Å, more preferably from 3 Å to about 4.5 Å, and most preferably from 3.5 Å to about 4.2 Å. Pore size can be determined by procedures known to those skilled in the art. Therefore as referred to herein, when only one number is mentioned as the pore size of the molecular sieve, minor variations of that pore size are acceptable.

Molecular sieves have a molecular framework of one, preferably two or more corner-sharing [TO₄] tetrahedral units, more preferably, two or more of [SiO₄], [AlO₄] and/or [PO₄] tetrahedral units, and most preferably [SiO₄], [AlO₄] and [PO₄] tetrahedral units. These silicon, aluminum, and/or phosphorous based molecular sieves and metal containing silicon, aluminum and/or phosphorous based molecular sieves have been described in detail in numerous publications including for example, U.S. Pat. No. 4,567,029 (MeAPO where Me is Mg, Mn, Zn, or Co), U.S. Pat. No. 4,440,871 (SAPO), European Patent Application EP-A-0 159 624 (ELAPSO where El is As, Be, B, Cr, Co, Ga, Ge, Fe, Li, Mg, Mn, Ti or Zn), U.S. Pat. No. 4,554,143 (FeAPO), U.S. Pat. Nos. 4,822,478, 4,683,217, 4,744,885 (FeAPSO), EP-A-0 158 975 and U.S. Pat. No. 4,935,216 (ZnAPSO), EP-A-0 161 489 (CoAPSO), EP-A-0 158 976 (ELAPO, where EL is Co, Fe, Mg, Mn, Ti or Zn), U.S. Pat. No. 4,310,440 (AlPO₄), EP-A-0 158 350 (SENAPSO), U.S. Pat. No. 4,973,460 (LiAPSO), U.S. Pat. No. 4,789,535 (LiAPO), U.S. Pat. No. 4,992,250 (GeAPSO), U.S. Pat. No. 4,888,167 (GeAPO), U.S. Pat. No. 5,057,295 (BAPSO), U.S. Pat. No. 4,738,837 (CrAPSO), U.S. Pat. Nos. 4,759,919, and 4,851,106 (CrAPO), U.S. Pat. Nos. 4,758,419, 4,882,038, 5,434,326 and 5,478,787 (MgAPSO), U.S. Pat. No. 4,554,143 (FeAPO), U.S. Pat. No. 4,894,213 (AsAPSO), U.S. Pat. No. 4,913,888 (AsAPO), U.S. Pat. Nos. 4,686,092, 4,846,956 and 4,793,833 (MnAPSO), U.S. Pat. Nos. 5,345,011 and 6,156,931 (MnAPO), U.S. Pat. No. 4,737,353 (BeAPSO), U.S. Pat. No. 4,940,570 (BeAPO), U.S. Pat. Nos. 4,801,309, 4,684,617 and 4,880,520 (TiAPSO), U.S. Pat. Nos. 4,500,651, 4,551,236 and 4,605,492 (TiAPO), U.S. Pat. Nos. 4,824,554, 4,744,970 (CoAPSO), U.S. Pat. No. 4,735,806 (GaAPSO) EP-A-0 293 937 (QAPSO, where Q is framework oxide unit [QO2]), as well as U.S. Pat. Nos. 4,567,029, 4,686,093, 4,781,814, 4,793,984, 4,801,364, 4,853,197, 4,917,876, 4,952,384, 4,956,164, 4,956,165, 4,973,785, 5,241,093, 5,493,066 and 5,675,050, all of which are herein fully incorporated by reference.

Other molecular sieves which may be used in connection with this invention include those described in R. Szostak, Handbook of Molecular Sieves, Van Nostrand Reinhold, New York, N.Y. (1992), which is herein fully incorporated herein by reference. Still other non-limiting examples of molecular sieve catalyst compositions suitable for the processes of the invention can be found in, inter alia, U.S. Patent Application Publication No. 2005-0107482, the disclosure of which is fully incorporated herein by reference.

The more preferred silicon, aluminum and/or phosphorous containing molecular sieves, and aluminum, phosphorous, and optionally silicon, containing molecular sieves include aluminophosphate (AlPO) molecular sieves and silicoaluminophosphate (SAPO) molecular sieves and substituted, preferably metal substituted, AlPO and SAPO molecular sieves. The most preferred molecular sieves are SAPO molecular sieves, and metal substituted SAPO molecular sieves.

Non-limiting examples of SAPO and AlPO molecular sieves useful in connection with the present invention include one or a combination of SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44 (U.S. Pat. No. 6,162,415), SAPO-47, SAPO-56, AlPO-5, AlPO-11, AlPO-18, AlPO-31, AlPO-34, AlPO-36, AlPO-37, AlPO-46, and metal containing forms thereof. Preferably, the molecular sieve is selected from the group consisting of SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44, SAPO-47, SAPO-56, the metal containing forms thereof, and mixtures thereof. The more preferred zeolite-type molecular sieves include one or a combination of SAPO-18, SAPO-34, SAPO-35, SAPO-44, SAPO-56, AlPO-18 and AlPO-34, and metal containing forms thereof, even more preferably one or a combination of SAPO-18, SAPO-34, AlPO-34 and AlPO-18, and metal containing forms thereof, and most preferably one or a combination of SAPO-34 and AlPO-18, and metal containing forms thereof. Optionally, the molecular sieve is selected from the group consisting of SAPO-34, the metal containing forms thereof. Another important class of SAPO molecular sieves consists of mixed or intergrown phases of molecular sieves having the CHA and AEI framework types. Examples of such materials are disclosed in WO 98/15496, published 16 Apr. 1998, in WO 02/070407, published Sep. 12, 2002, and U.S. Pat. No. 6,812,372, all herein fully incorporated by reference. Another example of an intergrowth combines offretite and erionite as in U.S. Pat. No. 4,086,186, namely an intergrowth of two kinds of crystalline molecular sieves having different topologies from each other.

In one embodiment, the molecular sieve is an intergrowth material having two or more distinct phases of crystalline structures within one molecular sieve composition. In particular, intergrowth molecular sieves are described in the U.S. Patent Application Pub. No. 2002/0165089 and PCT WO 98/15496 published Apr. 16, 1998, both of which are herein fully incorporated by reference. For example, SAPO-18, AlPO-18 and RUW-18 have an AEI framework-type, and SAPO-34 has a CHA framework-type. In another embodiment, the molecular sieve comprises at least one intergrown phase of AEI and CHA framework-types, preferably the molecular sieve has a greater amount of CHA framework-type to AEI framework-type, and more preferably the ratio of CHA to AEI is greater than 1:1 as determined by the DIFFaX method disclosed in U.S. Pat. No. 6,812,372.

In one embodiment, the molecular sieve, as described in many of the U.S. Patents mentioned above, is represented by the empirical formula, on an anhydrous basis:

mR:(MₓAl_{y}P_{z})O₂

wherein R represents at least one templating agent, preferably an organic templating agent; m is the number of moles of R per mole of (MₓAl_{y}P_{z})O₂ and m has a value from 0 to 1, preferably 0 to 0.5, and most preferably from 0 to 0.3; x, y, and z represent the mole fraction of Al, P, and M as tetrahedral oxides, where M is a metal selected from Groups 1-12 and the Lanthanides of the Periodic Table of Elements, preferably M is selected from one of the group consisting of Co, Cr, Cu, Fe, Ga, Ge, Mg, Mn, Ni, Sn, Ti, Y, Zn, and Zr. In an embodiment, m is greater than or equal to 0.2, and x, y and z are greater than or equal to 0.01. All numbers and references to the Periodic Table of Elements are based on the new notation as set out in Chemical and Engineering News, 63(5), 27 (1985). For the purposes of the present invention, a “templating agent” is any substance as a result of which the solid which is formed during generation of the at least one material from the synthesis mixture has at least one type of pore (micropores, mesopores, macropores).

In another embodiment, m is from about 0.1 to about 1, x is from about 0.01 to about 0.25, y is from about 0.4 to about 0.5, and z is in the range of from about 0.25 to about 0.5, more preferably m is from about 0.15 to about 0.7, x is from about 0.01 to about 0.2, y is from about 0.4 to about 0.5, and z is from about 0.3 to about 0.5.

Templating agents are generally compounds that contain elements of Group 15 of the Periodic Table of Elements, particularly nitrogen, phosphorus, arsenic and antimony, more preferably nitrogen or phosphorous, and most preferably nitrogen. Typical templating agents of Group 15 of the Periodic Table of elements also contain at least one alkyl or aryl group, preferably an alkyl or aryl group having from 1 to 10 carbon atoms, and more preferably from 1 to 8 carbon atoms. Examples of templating agents can include, but are not limited to, tetraalkylammonium (e.g., tetraethylammonium) salts (e.g., organic salt counterions such as acetate and the like, or inorganic salt counterions such as hydroxide, phosphate, halides, and the like, and combinations thereof), cyclopentylamine, aminoethyl cyclohexane, piperidines, trialkylamines (e.g., triethylamine), cyclohexylamine, dialkylcyclohexylamines (e.g., dimethyl cyclohexylamine), trialkyl hydroxyalkylamines, morpholines, dialkylamines (e.g., dipropylamine), pyridines, isopropylamines, and the like, and combinations thereof. Preferred templating agents typically include nitrogen-containing compounds such as amines and quaternary ammonium compounds. Other non-limiting examples of templating agents can be found in U.S. Pat. No. 6,906,232, column 8, lines 6-43, incorporated herein by reference.

In the case of SAPOs, for example, a reaction mixture can be formed by mixing together reactive silicon, aluminum and phosphorus components, along with at least one template. Generally, the mixture is sealed and heated, preferably under autogenous pressure, to a temperature of at least about 100° C., preferably from about 100 to about 250° C., until a crystalline product is formed. Formation of the crystalline product can take anywhere from about 2 hours to as much as about 2 weeks. In some cases, stirring or seeding with crystalline material can facilitate the formation of the product.

Typically, the molecular sieve product is formed in solution. It can be recovered by standard means, such as by centrifugation or filtration. The product can also be washed, recovered by the same means, and dried. Some SAPO molecular sieves, for example, can be synthesized by hydrothermal crystallization methods generally known in the art. See, e.g., U.S. Pat. Nos. 4,440,871; 4,861,743; 5,096,684; and 5,126,308, the disclosures of which relating to such methods are fully incorporated herein by reference. Additionally or alternately, zeolitic or non-zeolitic molecular sieves can be synthesized according to processes disclosed, e.g., in U.S. Pat. No. 5,939,349, in U.S. Patent Application Publication No. 2005/0101819 A1, in International Publication No. WO 2005/002726 A1, and/or in commonly-assigned, co-pending U.S. patent application entitled “Synthesis of Molecular Sieves and Their Use in the Conversion of Oxygenates to Olefins”, filed May 26, 2006, the disclosure of each of which is fully incorporated herein by reference.

The molecular sieve, in a preferred embodiment, is combined with one or more matrix material(s). Matrix materials are typically effective in reducing overall catalyst cost, act as thermal sinks assisting in shielding heat from the catalyst composition for example during regeneration, densifying the catalyst composition, increasing catalyst strength such as crush strength and attrition resistance, and to control the rate of conversion in a particular process.

Non-limiting examples of matrix materials include one or more of: rare earth metals, metal oxides including titania, zirconia, magnesia, thoria, beryllia, quartz, silica or sols (dispersions of small solid particles in a liquid), and mixtures thereof, for example silica-magnesia, silica-zirconia, silica-titania, silica-alumina and silica-alumina-thoria. In an embodiment, matrix materials are natural clays such as those from the families of montmorillonite and kaolin. These natural clays include subbentonites and those kaolins known as, for example, Dixie, McNamee, Georgia and Florida clays. Non-limiting examples of other matrix materials include: haloysite, kaolinite, dickite, nacrite, or anauxite. In one embodiment, the matrix material, preferably any of the clays, is subjected to well known modification processes such as calcination and/or acid treatment and/or chemical treatment.

In one preferred embodiment, the matrix material is a clay or a clay-type composition, preferably a clay or clay-type composition having a low iron or titania content, and most preferably the matrix material is kaolin. Kaolin has been found to form a pumpable, high solid content slurry, it has a low fresh surface area, and it packs together easily due to its platelet structure. A preferred average particle size (D₅₀) of the matrix material, most preferably kaolin, is from about 0.1 μm to about 0.6 μm with a particle size distribution such that the D₉₀ can be less than about 1 μm. As used herein, average particle size can be measured by Atomic Force Microscopy (AFM), Scanning Electron Microscopy (SEM), or Particle Size Analysis (e.g., using a Malvern PSA).

In another embodiment, the binders are alumina sols, predominantly comprising aluminum oxide, optionally including some silicon. In yet another embodiment, the binders are peptized alumina made by treating alumina hydrates such as pseudoboehmite, with an acid, preferably an acid that does not contain a halogen, to prepare sols or aluminum ion solutions. Non-limiting examples of commercially available colloidal alumina sols include Nalco™ 8676 available from Nalco Chemical Co., Naperville, Ill., and Nyacol™ available from The PQ Corporation, Valley Forge, Pa.

In one embodiment, the binder, templating agent, and the molecular sieve and the matrix material are combined to form a molecular sieve catalyst composition, where the amount of binder is from about 2% by weight to about 30% by weight, preferably from about 5% by weight to about 20% by weight, and more preferably from about 7% by weight to about 15% by weight, based on the total weight of the binder, the molecular sieve and matrix material, excluding the liquid (after calcination).

In another embodiment, the weight ratio of the binder to the matrix material used in the formation of the molecular sieve catalyst composition is from about 0:1 to about 1:15, preferably from about 1:5 to about 1:15, more preferably from about 1:4 to about 1:10, and most preferably from about 1:5 to about 1:6. It has been found that a higher sieve content, lower matrix content, increases the molecular sieve catalyst composition performance; however, lower sieve content, higher matrix material, improves the attrition resistance of the composition.

The molecular sieve and matrix material, and the optional binder, are combined in any order, together, simultaneously, sequentially, or a combination thereof.

In an embodiment, the average particle size of the molecular sieve particles (i.e., including the matrix material and the optional binder) is preferably less than about 300 microns, more preferably less than about 200 microns and most preferably less than about 150 microns.

As a result of the crystallization process, the recovered sieve generally contains within its pores at least a portion of the template used in making the initial reaction mixture. The crystalline structure essentially wraps around the template, and the template must be partly or completely removed for the molecular sieve to exhibit optimal catalytic activity. Once the template is removed or partially removed, the crystalline structure that remains has what is typically called an intracrystalline pore system.

In many cases, depending upon the nature of the final product formed, the template may be too large to be eluted from the intracrystalline pore system. In such a case, the template can be removed by a heat treatment process. For example, the template can be calcined, or essentially combusted, in the presence of an oxygen-containing gas, by contacting the template-containing sieve in the presence of the oxygen-containing gas and heating at temperatures from about 200° C. to about 900° C. In some cases, it may be desirable to heat in an environment having a low oxygen concentration. In these cases, however, the result will typically be a breakdown of the template into a smaller component, rather than by the combustion process. This type of process can be used for partial or complete removal of the template from the intracrystalline pore system. In other cases, with smaller templates, complete or partial removal from the sieve can be accomplished by conventional desorption processes such as those used in making standard zeolites.

In embodiments where it is desired to form molecular sieves that are substantially free from templating agents (for undergoing further treatment), this goal can be achieved by treating a templating agent-containing molecular sieve, such as one formed by the process described above, under conditions sufficient (e.g., calcining at a temperature above about 200° C., preferably above about 300° C.) to substantially remove the templating agent(s).

### C. Modification of Molecular Sieves

### 1. Starting with a Substantially Template-Free Molecular Sieve

In one embodiment according to the invention, the modification process can begin with providing a molecular sieve that is substantially free from templating agents (templates). For example, this can be accomplished by first providing a molecular sieve that contains one or more templating agents within its pores, and by second treating the templating agent-containing molecular sieve to substantially decompose/remove the one or more templating agent(s). In one embodiment, the second treating step can involve calcining the template agent-containing molecular sieve at a temperature, at a pressure, in an atmosphere, and for a time sufficient to substantially decompose/remove the one or more templating agent(s). The particulars of the temperature, pressure, atmosphere, and time should vary with the chemical and physical characteristics of the one or more templating agents and/or the molecular sieve, as well as other factors such as environmental impact of decomposition products.

As used herein, the phrases “substantially free from” and “substantially {component}-free,” particularly regarding a component with respect to a composition, should be understood to mean that the composition contains no more than about 1 wt % of the component, preferably no more than about 0.5 wt %, more preferably no more than about 0.1 wt %, for example no more than about 0.01 wt %. Thus, as used herein, the term “substantially” should be understood to mean at least about 99% (by weight, if applicable), preferably at least about 99.5%, more preferably at least about 99.9%, for example at least about 99.99%. In certain embodiments of the cases above, “substantially” can mean completely.

Once a substantially template-free molecular sieve is formed, it can be contacted with a metal salt solution in an organic medium in order to disperse the salt on the surface and/or in/among the pores of the molecular sieve. As used herein, the phrase “metal salt solution” is not limited to soluble/miscible mixtures of metal salt(s) and organic medium and should be understood to encompass combinations of metal salt(s) and non-solid (i.e., liquid and/or gaseous, preferably at least predominantly liquid) organic carrier(s) (comprising the medium), whether the salt(s) is(are) soluble enough in the carrier(s) to form a solution (i.e., where the organic carrier(s) can be considered solvent(s)) or is(are) partially insoluble in the carrier(s) so as to form a colloid, dispersion, slurry, micellar arrangement, at least partially phase separated liquid, or the like, or combination thereof.

In a preferred embodiment, the metal salt(s) can preferably be substantially in solution in the organic carrier(s). As used herein, the phrase “substantially in solution,” particularly with reference to a component-medium mixture, should be understood to mean that the component and the medium are soluble to the extent that the resulting mixture is substantially free from particles having a diameter (or largest dimension, if not relatively spherical in shape) that is greater than the smallest wavelength of visible light (i.e., at least about 400 nm, preferably at least about 380 nm).

Although the specific metal(s) in the metal salt(s) can be tailored to the desired molecular sieve catalyst, to the particular catalytic process for use, for the desired catalytic activity, and/or for an appropriate cost-benefit, the metal(s) can, in one embodiment, include, but is(are) not limited to, alkali metals, alkaline earth metals, transition metals, rare earth metals, and combinations thereof. In another embodiment, the metal(s) can include, but is(are) not limited to, metals of Group IA (based on the CAS version of the Periodic Table of Elements), metals of Group IIA, metals of Group IB, metals of Group IIB, metals of Group IIIB, metals of Group IVB, metals of Group VB, metals of Group VIB, metals of Group VIIB, metals of Group VIII (Group VIIIB), lanthanide metals, gallium, germanium, indium, tin, antimony, thallium, bismuth, thorium, and any combination thereof. In a preferred embodiment, the metal(s) can include, but is(are) not limited to, Bi, Cd, Ce, Co, Cr, Cu, Fe, Ga, Ge, In, La, Mg, Mn, Mo, Ni, Pd, Pt, Rh, Sb, Sc, Sn, Th, Ti, Tl, Y, Yb, Zn, Zr, or a combination thereof. In a more preferred embodiment, the metal(s) can include, but is(are) not limited to, Ni, Pt, Pd, Sn, Mo, Y, Ge, Sc, La, or a combination thereof.

Further, although the specific metal counterion(s) in the metal salt(s) can be tailored to the desired molecular sieve catalyst, to the particular catalytic process for use, for the desired catalytic activity, and/or for an appropriate cost-benefit, the counterion(s) can preferably include, but is(are) not limited to, organic counterions. In another embodiment, the counterion(s) can include, but is(are) not limited to, a carbonyl, a carboxylate, a carbonate, an amine, an amide, an ether, an aromatic moiety, a conjugated hydrocarbon moiety, an aliphatic hydrocarbon, or a mixture or combination thereof. In a preferred embodiment, the counterion(s) can include, but is(are) not limited to, a carboxylate, such as selected from the group consisting of: formate, acetate, propionate, a butyrate, hydroxyacetate, a haloacetate, oxalate, malonate, succinate, citrate, tartrate, lactate, benzoate, phthalate, and combinations thereof.

The organic medium comprises one or more organic carriers, which can be tailored, similarly to the metal(s) and counterion(s), to the desired molecular sieve catalyst, to the particular catalytic process for use, for the desired catalytic activity, and/or for an appropriate cost-benefit, so long as the catalyst (molecular sieve) property(ies) is(are) not unduly impacted. As used herein, the adjective “organic,” in reference to a composition but not a molecule/component, should be understood to mean that the composition comprises at least a majority of carbon-containing components. For instance, water is not organic, as defined herein; however, a composition containing water can be organic, provided that more than 50 wt % of the composition is made up of carbon-containing components.

Undue impact on catalyst properties can be manifest, for example, by loss in crystallinity. With respect to molecular sieves, loss in crystallinity can be measured via methanol adsorption capacity (MAC), via x-ray diffraction (XRD), or both. In the present invention, it is believed that undue impact on the sieve crystallinity can arise when the loss in sieve crystallinity approaches 50%, preferably when the loss in sieve crystallinity becomes greater than about 40%. For instance, when water is used as the sole medium for a metal salt and is contacted with a molecular sieve containing at least two of aluminum, phosphorus, and silicon, to disperse the metal salt, the molecular sieve can lose more than 50% of its crystallinity. Without being bound by theory, it is believed that relatively large concentrations of water can, when subject to many environments, destroy the sieve crystallinity, by essentially causing a reverse molecular sieve synthesis process to take place. Nevertheless, in the present invention, water can constitute a minor (i.e., less than 50 wt %) component of the organic medium, when combined with a majority (i.e., greater than 50 wt %) of organic carrier(s).

Examples of organic carriers suitable for use in the organic medium according to the invention can include, but are not limited to, alkanes, cycloalkanes, aromatics, alkyl halides, alkylene halides, alcohols, ketones, ethers, esters, amides, aldehydes, nitrites, and mixtures or combinations thereof. In a preferred embodiment, the organic medium comprises a C₁-C₆ alcohol, most preferably methanol. In a particularly preferred embodiment, the organic medium comprises a majority of methanol and from greater than 5 wt % to about 35 wt % water, preferably from about 8 wt % to about 30 wt % water, for example from about 10 wt % to about 25 wt % water.

It is preferred that the metal salt(s) is(are) dispersed via the organic carrier(s) under conditions sufficient to, as much as possible, attain relatively uniform (preferably substantially uniform) dispersal of the metal salt(s) on the surface and/or in/among the pores of the molecular sieve catalyst. In one embodiment, the sufficient conditions can include, but are not limited to, a temperature in the range from about 20° C. to about 60° C., preferably from about 25° C. to about 50° C.; a pressure in the range from about 0.8 atm to about 10 atm, preferably from about 1 atm to about 5 atm; a contact time from about 10 minutes to about 24 hours; or a combination thereof.

In some embodiments, the metal salt(s) may be dispersed on the molecular sieve by itself. Although this application is described below as if the metal salt(s) is(are) dispersed on the molecular sieve only, the metal salt(s) may additionally or alternately be dispersed on a catalyst composition comprising a molecular sieve, matrix, binder, and optional fillers.

Once the metal salt(s) has(have) been contacted with the molecular sieve and dispersed to form a metal-containing molecular sieve, that metal-containing molecular sieve can then be treated to form a modified molecular sieve. The treatment is typically performed under conditions sufficient to substantially remove/decompose the organic medium/carrier(s) and/or to oxidize the metal salt(s). Where oxidation of the metal salt(s) is desired, the treatment conditions can preferably be such that at least a majority (based on mole percent) of the metal salt(s) is(are) oxidized to form one or more metal oxides. In a preferred embodiment, the treatment conditions can be sufficient to oxidize the metal salt(s) to form at least about 75 mol % metal oxide(s), preferably at least about 90 mol % metal oxide(s), more preferably at least about 95 mol % metal oxide(s), for example to substantially oxidize the metal salt(s) into metal oxide(s).

In one embodiment, the treatment of the metal-containing molecular sieve can be accomplished under calcining conditions, which can be adapted to the particular molecular sieve, the particular medium, and/or the particular metal(s), so as preferably not to be destructive to the chemical, catalytic, and/or physical properties of the metal-containing and/or modified molecular sieve. In a preferred embodiment, the calcining conditions mentioned above can also be effective in substantially removing/decomposing the medium. For example, where the sieve comprises a silicoaluminophosphate and the metal comprises a transition and/or rare earth metal, the treatment can preferably include calcining at temperatures from about 400° C. to about 900° C. and typically in a relatively inert atmosphere (e.g., nitrogen and/or air).

The process for modifying the molecular sieve is preferably conducted so as to not cause the molecular sieve to lose more than about 50% crystallinity, preferably to lose not more than about 40% crystallinity. Without being bound by theory, it is believed that one of the largest contributions to loss of sieve crystallinity is the impact of contact between the medium and the molecular sieve during the metal salt(s) dispersal. For instance, when water is present in too high a concentration, the intimate contact between the water in the medium and the molecular sieve typically causes the crystallinity of the molecular sieve to decrease significantly, although the mechanism by which this occurs is not necessarily well understood. Indeed, in situations such as when water is the sole medium for the metal salt(s), the crystallinity of the molecular sieve can undesirably decrease during the modification process, for example, by as much as 50% or more.

Loss of sieve crystallinity can be measured by many methods. For instance, methanol absorption capacity index (MACI) can be used as an indirect indicator of sieve crystallinity. MACI is defined herein as the ratio of the methanol absorption capacity (MAC) of a molecular sieve modified in a given medium to the MAC of a molecular sieve modified in a medium of 100% methanol. Loss in sieve crystallinity based on methanol absorption capacity is expressed as (1-MACI).

Additionally or alternately, X-ray diffraction (XRD) can be used as a direct indicator of sieve crystallinity. average of 5 strongest XRD peak height ratios at a 2Θ value below about 25° for sieve modified in medium to sieve modified in ˜100% methanol. Information on relative crystallinity can be gleaned by analyzing the peak heights/intensities of the five strongest peaks in the 2Θ range below about 25°. The average ratio of peak heights (PHR_{avg}) over those five peaks of the molecular sieve modified in a given medium to the molecular sieve modified in a medium of ˜100% methanol. Loss in sieve crystallinity based on x-ray diffraction is expressed (1−PHR_{avg}).

Once the metal-containing molecular sieve is treated to form the modified molecular sieve, the modified molecular sieve can optionally be stored so as to preserve its catalytic activity (see, e.g., U.S. Pat. Nos. 6,316,683, 6,897,179, and 7,015,174, and U.S. Patent Application Publication Nos. 2005-0035027, 2005-0038306, and 2006-0094593, the disclosures of all of which are fully incorporated by reference herein). In addition, the modified molecular sieves made according to the processes of the invention can advantageously be used to catalyze one or more of a variety of chemical processes, e.g., naphtha reforming, steam reforming, carbonaceous (e.g., CO) combustion, dehydrogenation, hydrogenation, dewaxing, oxygenate-to-olefin (OTO) conversion, condensation, dehydration, hydration, (co)polymerization, (co)oligomerization, and the like, and combinations thereof.

### 2. Using a Semi-Aqueous Medium to Disperse the Metal Salt(s)

In another embodiment according to the invention, the modification process can begin with providing a molecular sieve having a surface and appropriately sized pores. In this embodiment, the molecular sieve may be substantially free from templating agents, or may contain one or more templating agents. As described above, in embodiments where it is desired to use molecular sieves that are substantially free from templating agents, this can be achieved by treating a templating agent-containing molecular sieve under conditions sufficient (e.g., calcining at a temperature above about 200° C., preferably above about 300° C.) to substantially remove the templating agent(s). In certain cases, particularly where the atmosphere can be destructive to the chemical, catalytic, and/or physical properties of the molecular sieve, the temperature can have an upper bound, e.g., about 900° C., in some cases about 800° C., or even as low as about 750° C., so as not to significantly degrade/decompose the molecular sieve. Without being bound by theory, it is believed that, in certain embodiments, the substantial removal of the templating agent(s) can improve the uniformity of dispersion of the metal salt, particularly in/among the pores of the sieve material. Additionally or alternately, again without being bound by theory, it is believed that, in certain embodiments, the substantial removal of the templating agent(s) can improve the ultimate activity of the modified molecular sieve (i.e., subsequent to treatment/oxidation of the metal salt-coated sieve).

The provided molecular sieve can then, as above, be contacted with a metal salt solution in a semi-aqueous medium under conditions sufficient to disperse the metal salt(s) on the surface and/or in/among the pores of the molecular sieve. As used herein, the term “semi-aqueous” should be understood to include compositions that contain water in an amount from greater than 5 wt % to about 35 wt %, preferably from about 8 wt % to about 30 wt %, for example from about 10 wt % to about 25 wt %. Preferably, the semi-aqueous medium is also an organic medium, thus further comprising a majority of one or more organic carriers. In a preferred aspect of that embodiment, the semi-aqueous organic medium comprises a C₁-C₆ alcohol, most preferably methanol.

As acknowledged hereinabove, many publications teach processes that use either aqueous solutions (mostly water, optionally including acids or bases) or non-aqueous solutions (containing less than 5 wt % water). First of all, many catalytic molecular sieves have hydrothermal stability problems, i.e., they significantly degrade, decompose, and/or lose catalytic activity when exposed to moisture/water. See, e.g., U.S. Pat. No. 6,316,683, the disclosure of which is fully incorporated herein by reference. Thus, it is believed that, in many circumstances, the use of aqueous solutions as carriers for modifying metal-containing compounds in post-processing can cause undesirable results. Second, the use of non-aqueous solution media can overcome the hydrothermal stability problem but introduces another issue, namely that even relatively polar organic media can sometimes have difficulty in solvating metal salts while remaining relatively inert to (e.g., substantially not reacting with) those salts. Thus, without being bound by theory, it is believed that what one gains in retaining the molecular sieve activity with non-aqueous solvents, one loses in carrier effectiveness and loading capacity of the resulting solution.

Instead, it has been proposed herein that semi-aqueous solutions containing some intermediate amount of water mixed with one or more organic carriers can simultaneously alleviate both the activity/stability issue of aqueous solutions and the solvation/loading issue of non-aqueous solutions.

In a preferred embodiment, the metal salt(s) can preferably be substantially in solution in the semi-aqueous medium. As above, the specific metal(s) and/or the specific metal counterion(s) in the metal salt(s) can be tailored to the desired molecular sieve catalyst, to the particular catalytic process for use, for the desired catalytic activity, and/or for an appropriate cost-benefit. Similarly, the make-up of the semi-aqueous medium can be tailored to the desired molecular sieve catalyst, to the particular catalytic process for use, for the desired catalytic activity, and/or for an appropriate cost-benefit, so long as the catalyst (molecular sieve) property(ies) is(are) not unduly impacted.

It is preferred that the metal salt(s) is(are) dispersed via the semi-aqueous medium under conditions sufficient to, as much as possible, attain relatively uniform (preferably substantially uniform) dispersal of the metal salt(s) on the surface and/or in/among the pores of the molecular sieve catalyst. In one embodiment, the sufficient conditions can include, but are not limited to, a temperature in the range from about 20° C. to about 60° C., preferably from about 25° C. to about 50° C.; a pressure in the range from about 0.8 atm to about 10 atm, preferably from about 1 atm to about 5 atm; a contact time from about 10 minutes to about 24 hours; or a combination thereof.

In some embodiments, the metal salt(s) may be dispersed on the molecular sieve by itself. Although this application is described below as if the metal salt(s) is(are) dispersed on the molecular sieve only, the metal salt(s) may additionally or alternately be dispersed on a catalyst composition comprising a molecular sieve, matrix, binder, and optional fillers.

Once the metal salt(s) has(have) been contacted with the molecular sieve and dispersed to form a metal-containing molecular sieve, that metal-containing molecular sieve can then be treated to form a modified molecular sieve. The treatment is typically performed under conditions sufficient to substantially remove/decompose the semi-aqueous medium and/or to oxidize the metal salt(s). Where oxidation of the metal salt(s) is desired, the treatment conditions can preferably be such that at least a majority (based on mole percent) of the metal salt(s) is(are) oxidized to form one or more metal oxides. In a preferred embodiment, the treatment conditions can be sufficient to oxidize the metal salt(s) to form at least about 75 mol % metal oxide(s), preferably at least about 90 mol % metal oxide(s), more preferably at least about 95 mol % metal oxide(s), for example to substantially oxidize the metal salt(s) into metal oxide(s).

In one embodiment, the treatment of the metal-containing molecular sieve can be accomplished under calcining conditions, which can be adapted to the particular molecular sieve, the particular medium, and/or the particular metal(s), so as preferably not to be destructive to the chemical, catalytic, and/or physical properties of the metal-containing and/or modified molecular sieve. In a preferred embodiment, the calcining conditions mentioned above can also be effective in substantially removing/decomposing the medium. For example, where the sieve comprises a silicoaluminophosphate and the metal comprises a transition and/or rare earth metal, the treatment can preferably include calcining at temperatures from about 400° C. to about 900° C. and typically in a relatively inert atmosphere (e.g., nitrogen and/or air).

As above, the process for modifying the molecular sieve is preferably conducted so as to not cause the molecular sieve to lose more than about 50% crystallinity, preferably to lose not more than about 40% crystallinity.

Once the metal-containing molecular sieve is treated to form the modified molecular sieve, the modified molecular sieve can optionally be stored so as to preserve its catalytic activity (see, e.g., U.S. Pat. Nos. 6,316,683, 6,897,179, and 7,015,174, and U.S. Patent Application Publication Nos. 2005-0035027, 2005-0038306, and 2006-0094593, the disclosures of all of which are fully incorporated by reference herein). In addition, the modified molecular sieves made according to the processes of the invention can advantageously be used to catalyze one or more of a variety of chemical processes, e.g., naphtha reforming, steam reforming, carbonaceous (e.g., CO) combustion, dehydrogenation, hydrogenation, dewaxing, oxygenate-to-olefin (OTO) conversion, condensation, dehydration, hydration, (co)polymerization, (co)oligomerization, and the like, and combinations thereof.

### D. Examples

The present invention can be better understood in view of the following non-limiting example described below.

### Example 1

### Nickel-Coated Silicoaluminophosphate Prepared by a Process According to the Invention

In Example 1, a SAPO-34 molecular sieve was synthesized according to Flanigan, E. M.; Patton, R. L.; and Wilson, S. T., Stud Surf. Sci. Catal., 37, 13 (1988) (the disclosure of which is fully incorporated herein by reference), using a morpholine template. This morpholine-containing SAPO-34 had a Si/Al₂ ratio of about 0.64. This morpholine SAPO-34 was calcined at about 650° C. for about 5 hours in a nitrogen atmosphere and then for about 3 hours in an air atmosphere at about atmospheric pressure to substantially decompose/remove the template.

Three nickel-containing solutions were formed to test the effects of solution medium on the coating process of the invention. Nickel acetate tetrahydrate was used as the metal salt in each solution. In Control Solution A, about 1.5 wt % nickel acetate tetrahydrate was added to deionized water to form a substantially aqueous nickel-containing solution. In Control Solution B, about 1.5 wt % nickel acetate tetrahydrate was added to methanol to form a substantially non-aqueous nickel-containing solution. In Solution C, about 1.5 wt % nickel acetate tetrahydrate was added to a mixture of about 10 wt % deionized water and about 90 wt % methanol to form a semi-aqueous nickel-containing solution.

To three samples of about 1 gram each of calcined morpholine SAPO-34, about 1.4 grams of nickel-containing solutions A, B, and C were added dropwise, respectively, and were each stirred with a spatula until gel-/paste- like substances were obtained. Once the sieves were impregnated with nickel, the samples were each placed in a vacuum oven, exposed to a reduced pressure of about 0.15 atmosphere and a temperature of about 50° C., for about 2 hours or until substantially all the solution mediums (i.e., water and/or methanol) were removed/evaporated. Thereafter, the substantially medium-free impregnated sieves were each treated to oxidize the nickel, i.e., through calcination at a temperature of about 650° C. for about 5 hours in a nitrogen atmosphere and then for about 3 hours in an air atmosphere at about atmospheric pressure. After treatment/calcination, each of the morpholine SAPO-34 sieves had an oxidized nickel coating.

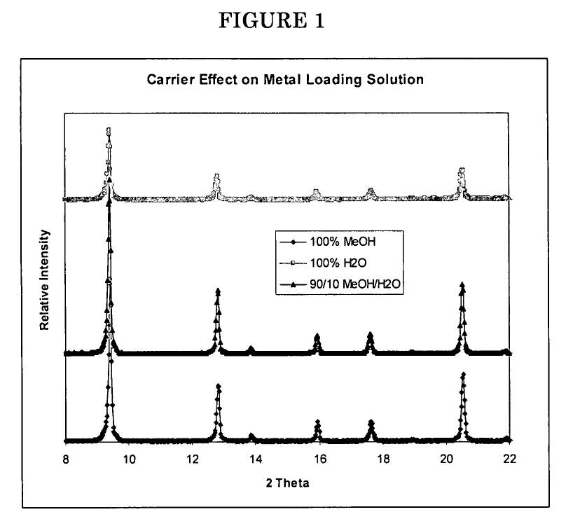

Each of the oxidized nickel-coated sieves was characterized to determine its nickel loading/content (expressed in weight percent of nickel equivalent) by wet chemical analysis techniques (e.g., atomic absorption spectroscopy) and to determine its relative crystallinity by methanol adsorption (expressed in weight percent methanol adsorbed) and by X-ray diffraction (XRD). The XRD characterization results for each sample are shown graphically in FIG. 1, and the other characterization results are shown numerically in Table 1 below.

TABLE 1

| SAPO + | Methanol | Water | Ni loading | MeOH ads. |
|---|---|---|---|---|
| Solution # | (wt %) | (wt %) | (wt %) | cap. (wt %) |
| A | 0 | 100 | 0.43 | 11.0 |
| B | 100 | 0 | 0.45 | 23.0 |
| C | 90 | 10 | 0.49 | 23.1 |

As can be seen from the results in Table 1, all three solutions deposited about 0.4-0.5 wt % nickel on their respective sieves; the sieve impregnated with solution C has a slightly higher loading than the others. However, the methanol adsorption capacities of the sieves impregnated with solutions B and C (low water content) are significantly higher than the sieve impregnated with solution A (high water content).

As mentioned above, methanol adsorption capacity index (MACI) can be used as an indirect indicator of sieve crystallinity. The MACI values of the sieves impregnated with solutions B and C are both around 1 (i.e., substantially no loss of crystallinity when impregnated with low water content solutions), whereas the MACI value of the sieve impregnated with solution A is below 0.5 (i.e., the sieve crystallinity is more than cut in half when impregnated with a high water content solution).

X-ray diffraction is a direct indicator of sieve crystallinity, e.g., by examining the peak heights/intensities, for example, at 2Θ values below about 25°. By analyzing the average peak heights/intensities of the five strongest peaks in that range and comparing them, a loss in sieve crystallinity can be measured. Based on the XRD spectra in FIG. 1, the sieves impregnated with solutions B and C both around exhibit losses in sieve crystallinity of about 0%, whereas the sieve impregnated with solution A exhibited a loss in sieve crystallinity above 50%. These losses in sieve crystallinity from FIG. 1 were calculated from comparison of the peak height ratios of the peaks at the following 2Θ values: approximately 9.4°; approximately 12.8°; approximately 15.9°; approximately 17.6°; and approximately 20.5°.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

What is claimed is:

1. A process for preparing a modified molecular sieve, said process comprising:
a. providing a molecular sieve comprising a surface and pores that are substantially free from templating agents;
b. contacting the molecular sieve with a metal salt in an organic medium under conditions sufficient to disperse the metal salt on the surface, and optionally in the pores, of the molecular sieve to form a metal-containing molecular sieve; and
c. treating the metal-containing molecular sieve under conditions sufficient to form a modified molecular sieve having a loss in molecular sieve crystallinity of not more than about 40%.

2. The process of claim 1, wherein the providing step comprises:
(a1) providing a molecular sieve comprising pores in which one or more templating agents are disposed; and
(a2) treating the templating agent-containing molecular sieve under conditions sufficient to substantially remove the one or more templating agents, thereby forming a molecular sieve that is substantially free from templating agents.

3. The process of claim 1, wherein the molecular sieve in step a comprises Beta, ZSM-5, ZSM-11, ZSM-12, ZSM-12, ZSM-38, ZSM-22, ZSM-23, ZSM-34, ZSM-35, ZSM-48, ZSM-58, MCM-1, MCM-2, MCM-3, MCM-4, MCM-5, MCM-9, MCM-10, MCM-14, MCM-22, MCM-41, M-41S, MCM-48, MCM-49, MCM-56, TASO-45, a borosilicate, a titanium aluminophosphate, an intergrowth thereof, or a combination thereof.

4. The process of claim 1, wherein the molecular sieve in step a comprises a zeolitic molecular sieve selected from the group consisting of SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44, SAPO-47, SAPO-56, ALPO-5, ALPO-11, ALPO-18, ALPO-31, ALPO-34, ALPO-36, ALPO-37, ALPO-46, RUW-18, an intergrowth thereof, and a combination thereof.

5. The process of claim 4, wherein the molecular sieve comprises SAPO-34, ALPO-18, SAPO-18, ALPO-34, an intergrowth thereof, or a combination thereof.

6. The process of claim 1, wherein the organic medium comprises an alkane, a cycloalkane, an aromatic, an alkyl halide, an alkylene halide, an alcohol, a ketone, an ether, an ester, an amide, an aldehyde, a nitrile, or a mixture or combination thereof.

7. The process of claim 6, wherein the organic medium comprises a C₁-C₆ alcohol.

8. The process of claim 7, wherein the organic medium comprises methanol.

9. The process of claim 1, wherein the organic medium is semi-aqueous.

10. The process of claim 9, wherein the organic medium comprises a C₁-C₆ alcohol.

11. The process of claim 1, wherein the metal salt is substantially in solution in the organic medium when contacting the molecular sieve.

12. The process of claim 1, wherein the metal salt comprises a metal selected from the group consisting of: Bi, Cd, Ce, Co, Cr, Cu, Fe, Ga, Ge, In, La, Mg, Mn, Mo, Ni, Pd, Pt, Rh, Sb, Sc, Sn, Th, Ti, Tl, Y, Yb, Zn, Zr, and combinations thereof.

13. The process of claim 12, wherein the metal is selected from the group consisting of Ni, Pt, Pd, Sn, Mo, Y, Ge, Sc, La, and combinations thereof.

14. The process of claim 1, wherein the metal salt comprises an organic counterion.

15. The process of claim 14, wherein the organic counterion comprises a carbonyl, a carboxylate, a carbonate, an amine, an amide, an ether, an aromatic moiety, a conjugated hydrocarbon moiety, an aliphatic hydrocarbon, or a mixture or combination thereof.

16. The process of claim 15, wherein the organic counterion comprises a carboxylate selected from the group consisting of: formate, acetate, propionate, a butyrate, hydroxyacetate, a haloacetate, oxalate, malonate, succinate, citrate, tartrate, lactate, benzoate, phthalate, and a combination thereof.

17. The process of claim 1, wherein the metal-containing molecular sieve is treated under conditions sufficient to substantially remove the organic medium and to oxidize the metal salt.

18. The process of claim 17, wherein oxidizing the metal salt comprises reacting the metal salt such that at least a majority thereof is converted to a metal oxide.

19. The process of claim 1, wherein the treating step is accomplished by increasing temperature, by decreasing pressure, or both.

20. The process of claim 1, wherein the modified molecular sieve exhibits a methanol adsorption capacity index of at least about 0.6.

21. The process of claim 20, wherein the methanol adsorption capacity index is at least about 0.8.

22. The process of claim 21, wherein the methanol adsorption capacity index is at least about 0.95.

23. The process of claim 1, wherein the modified molecular sieve exhibits a loss in sieve crystallinity, as measured by x-ray diffraction, of not more than about 0.4.

24. The process of claim 23, wherein the loss in sieve crystallinity is not more than about 0.2.

25. The process of claim 24, wherein the loss in sieve crystallinity is not more than about 0.05.

26. A process for preparing a modified molecular sieve, said process comprising:
a. providing a molecular sieve comprising a surface and pores;
b. contacting the molecular sieve with a metal salt in a semi-aqueous medium under conditions sufficient to disperse the metal salt on the surface, and optionally in the pores, of the molecular sieve to form a metal-containing molecular sieve; and
c. treating the metal-containing molecular sieve under conditions sufficient to form a modified molecular sieve having a loss in molecular sieve crystallinity of not more than about 40%.

27. The process of claim 26, wherein the pores of the molecular sieve provided in step a are substantially free from templating agents.

28. The process of claim 27, wherein the providing step comprises:
(a1) providing a molecular sieve comprising pores in which one or more templating agents are disposed; and
(a2) treating the templating agent-containing molecular sieve under conditions sufficient to substantially remove the one or more templating agents, thereby forming a molecular sieve substantially free from templating agents.

29. The process of claim 26, wherein the molecular sieve in step a comprises Beta, ZSM-5, ZSM-11, ZSM-12, ZSM-12, ZSM-38, ZSM-22, ZSM-23, ZSM-34, ZSM-35, ZSM-48, ZSM-58, MCM-1, MCM-2, MCM-3, MCM-4, MCM-5, MCM-9, MCM-10, MCM-14, MCM-22, MCM-41, M-41S, MCM-48, MCM-49, MCM-56, TASO-45, a borosilicate, a titanium aluminophosphate, an intergrowth thereof, or a combination thereof.

30. The process of claim 26, wherein the molecular sieve in step a comprises a zeolitic molecular sieve selected from the group consisting of SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44, SAPO-47, SAPO-56, ALPO-5, ALPO-11, ALPO-18, ALPO-31, ALPO-34, ALPO-36, ALPO-37, ALPO-46, RUW-18, an intergrowth thereof, and a combination thereof.

31. The process of claim 30, wherein the molecular sieve comprises SAPO-34, ALPO-18, SAPO-18, ALPO-34, an intergrowth thereof, or a combination thereof.

32. The process of claim 26, wherein the semi-aqueous medium is organic and comprises an alkane, a cycloalkane, an aromatic, an alkyl halide, an alkylene halide, an alcohol, a ketone, an ether, an ester, an amide, an aldehyde, a nitrile, or a mixture or combination thereof.

33. The process of claim 32, wherein the semi-aqueous medium comprises a C₁-C₆ alcohol.

34. The process of claim 33, wherein the C₁-C₆ alcohol is methanol.

35. The process of claim 26, wherein the metal salt is substantially in solution in the semi-aqueous medium when contacting the molecular sieve.

36. The process of claim 26, wherein the metal salt comprises a metal selected from the group consisting of: Bi, Cd, Ce, Co, Cr, Cu, Fe, Ga, Ge, In, La, Mg, Mn, Mo, Ni, Pd, Pt, Rh, Sb, Sc, Sn, Th, Ti, Ti, Y, Yb, Zn, Zr, and combinations thereof.

37. The process of claim 36, wherein the metal is selected from the group consisting of Ni, Pt, Pd, Sn, Mo, Y, Ge, Sc, La, and combinations thereof.

38. The process of claim 26, wherein the metal salt comprises an organic counterion.

39. The process of claim 38, wherein the organic counterion comprises a carbonyl, a carboxylate, a carbonate, an amine, an amide, an ether, an aromatic moiety, a conjugated hydrocarbon moiety, an aliphatic hydrocarbon, or a mixture or combination thereof.

40. The process of claim 39, wherein the organic counterion comprises a carboxylate selected from the group consisting of: formate, acetate, propionate, a butyrate, hydroxyacetate, a haloacetate, oxalate, malonate, succinate, citrate, tartrate, lactate, benzoate, phthalate, and a combination thereof.

41. The process of claim 26, wherein the metal-containing molecular sieve is treated under conditions sufficient to substantially remove the organic medium and to oxidize the metal salt.

42. The process of claim 41, wherein oxidizing the metal salt comprises reacting the metal salt such that at least a majority thereof is converted to a metal oxide.

43. The process of claim 26, wherein the treating step is accomplished by increasing temperature, by decreasing pressure, or both.

44. The process of claim 26, wherein the modified molecular sieve exhibits a methanol adsorption capacity index of at least about 0.6.

45. The process of claim 44, wherein the methanol adsorption capacity index is at least about 0.8.

46. The process of claim 45, wherein the methanol adsorption capacity index is at least about 0.95.

47. The process of claim 26, wherein the modified molecular sieve exhibits a loss in sieve crystallinity, as measured by x-ray diffraction, of not more than about 0.4.

48. The process of claim 47, wherein the loss in sieve crystallinity is not more than about 0.2.

49. The process of claim 48, wherein the loss in sieve crystallinity is not more than about 0.05.

50. A modified molecular sieve made according to the process of claim 1.

51. A modified molecular sieve made according to the process of claim 26.
